(19) United States
(12) Patent Application Publication
(10) Pub. No.: US 2005/0077501 A1
(43) Pub. Date: Apr. 14, 2005

(54) Azeotrope-like compositions of trifluoroethane and hydrogen fluoride

(75) Inventors: Hang T. Pham, Amherst, NY (US); Rajiv R. Singh, Getzville, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/684,781

(22) Filed: Oct. 14, 2003

(51) Int. Cl. B01F 1/00

(52) U.S. Cl. 252/364

(57) ABSTRACT

The invention relates to azeotropic and azeotrope-like mixtures of 1,1,1-trifluoroethane (HFC-143a) and hydrogen fluoride and a process for separating the azeotrope-like mixtures. The compositions of the invention are useful as an intermediate in the production of HFC-143a. The latter is useful as a nontoxic, zero ozone depleting fluorocarbon useful as a solvent, blowing agent, refrigerant, cleaning agent and aerosol propellant.

### FIELD OF THE INVENTION

The present invention relates to processes for the production of hydrofluorocarbon compounds, to compositions containing hydrofluorocarbons compounds, to processes for the production of such compounds and compositions, and to azeotropic and azeotrope-like compositions containing trifluoroethane and hydrogen fluoride.

### BACKGROUND

There is presently a substantial concern that chlorofluorocarbons, which are used on a large scale around the world, may be damaging the earth's protective ozone layer. This concern has been a major motivation behind recent, worldwide efforts to use fluorine-substituted hydrocarbons which contain fewer or no chlorine substituents. In fact, several items of international legislation now in effect will ensure that the manufacture and use of such ozone depleting compounds will be eliminated in the near future. Chlorofluorocarbons (CFC's) are frequently used, for example, as refrigerants, as foam blowing agents, as cleaning solvents and as propellants for aerosol sprays in which the variety of applications is virtually unlimited. Consequently, much effort is being devoted to finding suitable replacements for chlorofluorocarbons which will perform satisfactorily in the many applications in which chlorofluorocarbons are used but which will not have the aforementioned damaging effect on the ozone layer.

One approach in the search for suitable replacements has centered on fluorocarbons which do not contain chlorine but which contain hydrogen. The production of HFCs, i.e. compounds containing only carbon, hydrogen and fluorine, has been the subject of interest to provide environmentally desirable products for use as solvents, blowing agents, refrigerants, cleaning agents, aerosol propellants, heat transfer media, dielectrics, fire extinguishing compositions and power cycle working fluids. HFCs are thus considered to be preferred over hydrochlorofluorocarbons (HCFCs) and chlorofluorocarbons (CFCs) because they tend to be non-ozone depleting, non-flammable, and non-toxic as compared to the chlorine containing compounds.

There has been interest, for example, in 1,1,1,2-tetrafluoroethane (HFC-134a), difluoromethane (HFC-32), pentafluoroethane (HFC-125), 1,1-difluoroethane (HFC-152a) and 1,1,1-trifluoroethane (HFC-143a). These compounds, as well as mixtures containing one or more of these compounds, have been considered as replacements for CFCs in many of the above-noted applications. In this regard, 1,1,1-trifluoroethane (HFC-143a), a hydrofluorocarbon (HFC) having zero ozone depletion potential, is of particular interest as a replacement for chlorofluorocarbons such as chlorodifluoromethane, which are used frequently in refrigeration systems. HFC-143a is frequently produced as the result of a reaction with a reactive organic compound and a fluorination agent, which in many instances is hydrogen fluoride (HF). Thus, the reaction product from such reactions contains unreacted HF and HFC-143a. As described in detail hereinafter, applicants have discovered that certain combinations of HFC-143a and HF exhibit the unique and unpredictable property of azeotropy, and applicants have therefore have come to appreciate a need for improved processes directed specifically to the production of HFC-143a. In addition, HFC-143a is present as a reaction product in many fluorination reactions directed to the production of other fluorinated compounds. Thus, applicants have also come to appreciate a need more generally for improved processes directed to the production of HFCs and HCFCs.

### SUMMARY OF THE INVENTION

Applicants have discovered the existence of azeotrope and azeotrope-like compositions comprising 1,1,1-trifluoroethane and hydrogen fluoride. Moreover, applicants have discovered improved fluorination processes comprising fluorinating a reactive organic compound with a fluorination agent comprising HF to produce a reaction product mixture comprising HFC-143a and unreacted HF, and removing from the reaction product azeotrope and azeotrope-like compositions comprising 1,1,1-trifluoroethane and hydrogen fluoride. In certain optional but preferred embodiments of the method aspects of this invention, the azeotrope and azeotrope-like composition of this invention is thereafter separated into its component parts to produce compositions enriched in HFC-143a, enriched in HF, or both such enriched compositions may be produced. As used herein, the reference to enriched refers to the component having a higher concentration in the enriched composition relative to the concentration of that component in the azeotrope or azeotrope-like composition.

The azeotropic and azeotrope-like compositions find use not only in processes which involve the production of a reaction product mixture containing both HFC-143a and HF, but they are additionally useful as solvents, as well as compositions for removing surface oxidation from metals, and in processes for the removal of impurities from HFC-143a.

HFC-143a has a boiling point of about −47° C. (−53° F.) and hydrogen fluoride has a normal boiling point of about 20° C. (−68° F.) at standard atmospheric pressure. When it is desired to separate a mixture of 1,1,1-trifluoroethane and an impurity, hydrogen fluoride is added to form an azeotropic mixture of 1,1,1-trifluoroethane and hydrogen fluoride, and then the impurity is removed from the azeotropic mixture, such as by distillation (and in particular pressure swing distillation), scrubbing or other known means.

### BRIEF DESCRIPTION OF THE DRAWINGS

FIG. 1 shows a plot of the vapor pressures of HFC-143a and hydrogen fluoride at various compositions as measured at 19.9° C.

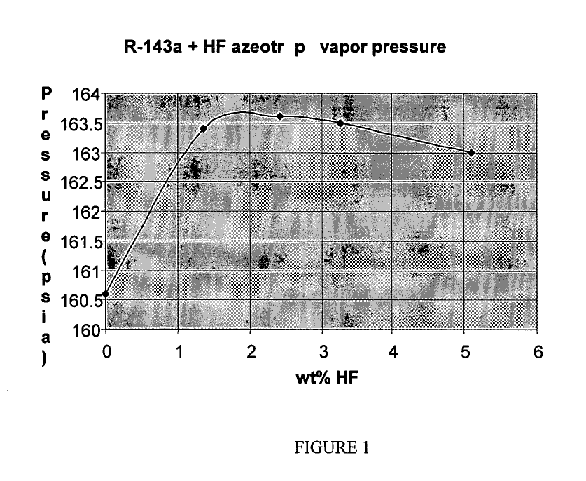

### DETAILED DESCRIPTION OF PREFERRED EMBODIMENTS

The Compositions

The invention provides an azeotrope and azeotrope-like compositions consisting essentially of trifluoroethane, preferably 1,1,1-trifluoroethane, and hydrogen fluoride. The invention further provides an azeotropic or azeotrope-like compositions which consist essentially of from about 90 to about 99.9 weight percent 1,1,1-trifluoroethane and from about 0.1 to about 10 weight percent hydrogen fluoride. In preferred embodiments the compositions of the present invention are characterized by a boiling point of about 20° C.±5° C. at a pressure of about 164 psia.

As mentioned above, applicants have discovered that HFC-143a forms azeotropic and azeotrope-like mixtures with hydrogen fluoride. The thermodynamic state of a fluid is defined by its pressure, temperature, liquid composition and vapor composition. For a true azeotropic composition, the liquid composition and vapor phase are essentially equal at a given temperature and pressure range. In practical terms this means that the components cannot be separated during a phase change. For the purpose of this invention, an azeotrope-like composition means that the composition behaves like a true azeotrope in,terms of its constant boiling characteristics and tendency not to fractionate upon boiling or evaporation. During boiling or evaporation, the liquid composition changes only slightly, if at all. This is in contrast with non-azeotrope-like compositions in which the liquid and vapor compositions change substantially during evaporation or condensation. One way to determine whether a candidate mixture is azeotrope-like within the meaning of this invention, is to distill a sample of it under conditions which would be expected to separate the mixture into its separate components. If the mixture is a non-azeotrope or non-azeotrope-like, the mixture will fractionate, i.e. separate into its various components with the lowest boiling component distilling off first, and so on. If the mixture is azeotrope-like, some finite amount of the first distillation cut will be obtained which contains all of the mixture components and which is constant boiling or behaves like a single substance. Another characteristic of azeotrope-like compositions is that there is a range of compositions containing the same components in varying proportions which are azeotrope-like. All such compositions are included by the term azeotrope-like as used herein. As an example, it is well known that at different pressures the composition of a given azeotrope will vary at least slightly as does the boiling point of the composition. Thus an azeotrope of two components represents a unique type of relationship but with a variable composition depending on the temperature and/or pressure. As is well known in the art, the boiling point of an azeotrope will generally vary with pressure.

As used herein, an azeotrope is a liquid mixture that exhibits a maximum or minimum boiling point relative to the boiling points of surrounding mixture compositions. An azeotrope or an azeotrope-like composition is an admixture of two or more different components which, when in liquid form under given pressure, will boil at a substantially constant temperature, which temperature may be higher or lower than the boiling temperatures of the components and which will provide a vapor composition essentially identical to the liquid composition undergoing boiling. For the purpose of this invention, azeotropic compositions are defined to include azeotrope-like compositions which means a composition that behaves like an azeotrope, i.e., has constant-boiling characteristics or a tendency not to fractionate upon boiling or evaporation. Thus, the composition of the vapor formed during boiling or evaporation is the same as or substantially the same as the original liquid composition. Hence, during boiling or evaporation, the liquid composition, if it changes at all, changes only to a minimal or negligible extent. This is in contrast with non-azeotrope-like compositions in which during boiling or evaporation, the liquid composition changes to a substantial degree. Accordingly, the essential features of an azeotrope or an azeotrope-like composition are that at a given pressure, the boiling point of the liquid composition is fixed and that the composition of the vapor above the boiling composition is essentially that of the boiling liquid composition, i.e., essentially no fractionation of the components of the liquid composition takes place. Both the boiling point and the weight percentages of each component of the azeotropic composition may change when the azeotrope or azeotrope-like liquid composition is subjected to boiling at different pressures. Thus, an azeotrope or an azeotrope-like composition may be defined in terms of the relationship that exists between its components or in terms of the compositional ranges of the components or in terms of exact weight percentages of each component of the composition characterized by a fixed boiling point at a specified pressure.

The present invention provides a composition which comprises effective amounts of hydrogen fluoride and HFC-143a to form an azeotropic or azeotrope-like composition. By effective amount is meant an amount of each component which, when combined with the other component, results in the formation of an azeotrope or azeotrope-like mixture at the given pressure of the mixture. The inventive compositions preferably are binary azeotropes which consist essentially of combinations of only hydrogen fluoride and HFC-143a.

In certain embodiments the present compositions contain from about 90 to about 99 weight percent HFC-143a and from about 1 to about 10 weight percent hydrogen fluoride, more preferably from about 95 weight percent to about 99 weight percent HFC-143a and from about 1 to about 5 weight percent hydrogen fluoride, and even more preferably from about 97 weight percent to about 99 weight percent HFC-143a and from about 1 to about 3 weight percent hydrogen fluoride.

The compositions of the present invention are also preferably characterized by a boiling point of about 20° C. at a pressure of about 164 psia. An azeotropic or azeotrope-like composition having about 3±2 weight percent hydrogen fluoride and about 97±2 weight percent HFC-143a has been found to boil at a temperature of about 20° C. and a pressure of about 164 psia.

The azeotropic or azeotrope-like mixtures of HFC-143a and hydrogen fluoride of the present invention may be a part of any stream containing the azeotropic mixture, as for example a fluorocarbon manufacturing process stream.

The Methods

Fluorination Processes

The method aspects of the present invention include improved fluorination processes comprising the steps of (a) fluorinating a reactive organic compound with a fluorinating agent comprising HF, preferably in the presence of a fluorination catalyst, to produce a reaction product comprising at least HFC-143a and unreacted HF; and (b) removing from said reaction product an azeotrope or an azeotrope-like composition comprising HFC-143a and HF; and (c) optionally but preferably separating at least a portion of said HF from said removed azeotrope or azeotrope-like composition to produce a stream enriched in HFC-143a. Optionally, but preferably, the separation step (c) may also include producing from said azeotrope or azeotrope-like composition a composition enriched in HF. When the above-noted optional separation step (c) is used, it is generally preferred that the HF so separated is recycled to the fluorination step. For embodiments which do not include the separation step (c), it is preferred in certain of those embodiments that the removed azeotrope or azeotrope-like composition is recycled to the fluorination step. It is also contemplated that in certain embodiments one portion of the removed composition is subjected to separation step (c) and another portion of the removed composition is recycled to the fluorination step (a).

The fluorination step of the present can be carried out in accordance with any process know in the prior art, and the particulars of all such processes are within the scope of the present invention and need not be explained in detail here. It is sufficient to note that it is common and well known in such processes that a mixture of halogenated compounds, HF and other byproducts are found in the product stream from such a reaction, and that in at least some of these reaction products both HFC-143a and HF are present. Thus, a mixture of reactants, byproducts and reaction intermediates of the process may be present along with the HFC-143a/hydrogen fluoride mixture.

The removing step of the present invention comprises one or more unit operations conducted under conditions effective to remove from the reaction product of the present invention an azeotrope or azeotrope-like composition of the present invention. The preferred removal steps of the present invention have been developed, at least in part, as a result of applicants' discovery that such azeotrope and azeotrope-like compositions are produced in certain processes for the production of CFCs, HFCs and/or HCFCs, and that advantage can be achieved by removing such compositions from the reaction product. As is typical, the reaction product from the fluorination step is typically processed so as to create one or more compositions containing relatively high concentrations of one or more desired CFCs, HFCs, or HCFCs. This processing once again typically involves on or more separation steps, and each such separation technique, such as fractionation, caustic scrubbing, and the like, is generally well known and need not be described herein in detail. However, this aspect of the present invention involves the recognition that in many of such separation steps azeotrope or azeotrope-like compositions may be formed and advantageously removed, for example by separation as a side, bottoms or overhead stream from a distillation column. As used herein, the term “removed from the reaction product” is intended to include not only removal from the reactor effluent per se, but also from any of the one or more process streams that are created as a result of downstream processing of the reactor effluent.

The optional step of separating at least a portion of the HF from the removed azeotrope of azeotrope-like composition can comprise any of well known techniques for breaking azeotropic compositions, such as by extraction techniques, including liquid-liquid extraction, pressure swing distillation, and like techniques. The separation techniques of this aspect of the invention, as well as the purification technique described hereinafter, may be accomplished, for example, by using a first distillation step operating at a first pressure and then, subsequently a second distillation step operated at a second pressure. Preferably, the process is practiced with a series of distillation columns, meaning at least two columns, operating at two or more different pressures. When a series of columns is used, the process may be carried out either in continuous or batch mode. Examples of distillation columns and methods suitable for use in the present invention are disclosed in U.S. Pat. No. 5,918,481 (issued to AlliedSignal), which is incorporated herein by reference.

In preferred methods, particularly methods of preparing HFC-143a in accordance with the present invention, precursor reagents are fluorinated with hydrogen fluoride. The reaction products of such precursors include HFC-143a, unreacted hydrogen fluoride and other by-products. Upon removal of the by-products, a binary azeotrope or azeotrope-like composition of HFC-143a and hydrogen fluoride is formed. This binary azeotrope or azeotrope-like composition is then available for removal from the product stream and separation into its component parts. The azeotropic or azeotrope-like compositions of the HFC-143a and hydrogen fluoride are also useful as recycle to the fluorination reactor. Thus, for example, in a process for producing HFC-143a, one can recover a portion of the HFC-143a as an azeotropic or azeotrope-like composition of HFC-143a and hydrogen fluoride and then recycle the composition to the reactor.

Azeotrope and Azeotrope-Like Formati n Methods

The invention also provides methods of forming an azeotropic or azeotrope-like composition which consists essentially of forming a composition containing from about 90 to about 99 weight percent 1,1,1-trifluoroethane and from about 1 to about 10 weight percent hydrogen fluoride, which composition has a boiling point of about 20° C. at a pressure of about 162±2 psia.

1,1,1-Trifluoroethane Purification Methods

Another aspect of the present invention provides a process for removing one or more impurities from a composition containing 1,1,1-trifluoroethane and at least one impurity. As used herein, the term “impurity” refers to any compound present in a mixture with 1,1,1-trifluoroethane from which it is desirable, for a given application, to separate the 1,1,1-trifluoroethane. The preferred aspects of this aspect of the invention comprise adding hydrogen fluoride to the mixture in an amount sufficient to form an azeotropic or azeotrope-like composition of the 1,1,1-trifluoroethane and the hydrogen fluoride, and thereafter separating the azeotropic composition from the impurity. This separation can be achieved by any one or more of known techniques, including for example by distillation, scrubbing, or other art-recognized separating means.

The impure compositions to be purified according to the present invention may originate from any one of a variety of sources, including for example, compositions which result from manufacturing steps in the preparation of 1,1,1-trifluoroethane. Preferably, the impurity itself does not form an azeotropic mixture with 1,1,1-trifluoroethane, hydrogen fluoride or a mixture of 1,1,1,3,3-pentafluorobutane and hydrogen fluoride. Typical impurities include other halocarbons which may be miscible with 1,1,1-trifluoroethane such as HCC-140a (1,1,1 trichloroethane).

Uses of the Compositions

The compositions of the present invention may be used in a wide variety of applications as substitutes for CFCs and HCFCs. For example, the present compositions are useful as solvents, blowing agents, refrigerants, cleaning agents and aerosols. In addition, the compositions of the present invention are particularly suited for use in producing relatively pure 1,1,1-trifluoroethane.

### EXAMPLES

The following non-limiting examples serve to illustrate but not limit the invention.

### Example 1

A series of binary, homogeneous compositions consisting essentially of 1,1,1-trifluoroethane (HFC-143a) and hydrogen fluoride are formed at 19.9° C. The vapor pressures of the mixtures were measured and are reported in Table 1 below.

TABLE 1

| WEIGHT PERCENT HF | PRESSURE (PSIA) @ 19.9° C. |
|---|---|
| 0 | 160.6 |
| 1.36 | 163.4 |
| 2.42 | 163.6 |
| 3.27 | 163.5 |
| 5.1 | 163 |

The data in the table above show that the vapor pressure of the composition is at a maximum of from about 1.5 weight percent HF to about 3.5 weight percent at about 19.9° C., thus revealing the existence of an azeotrope.

### Example 2

To a distillation column with thirty stages, column 1, is fed a mixture containing about 7 weight percent hydrogen fluoride and about 93 weight percent HFC-143a, simulating the azeotropic mixture that would be encountered in a typical process for preparing HFC-143a. Column 1 is brought to reflux at a pressure of about 200 psia. The bottoms stream from the column is essentially all hydrogen fluoride.

The column overhead, or distillate, is enriched in HFC-143a, and consists essentially of about 98 wt % HFC-143a and about 2 wt %: hydrogen fluoride. The overhead is transferred to a second column, with 20 stages and running at 18 psia. The overhead from this second column consists of about 95 wt % HFC-143a and about 5 wt % hydrogen fluoride. This overhead is recycled to column 1. The bottom of the second column is HFC-143a with only a trace of hydrogen fluoride.

1. An azeotropic or azeotrope-like composition which consists essentially of from greater than about 0 to about 10 weight percent hydrogen fluoride and from about 90 to about 99 weight percent 1,1,1-trifluoroethane (HFC-143a).

2. The composition of claim 1 consisting essentially of hydrogen fluoride and HFC-143a and having a vapor pressure of from about 160 to about 164 psia at about 20° C.

3. The composition of claim 1 consisting essentially of from about 95 weight percent to about 99 weight percent HFC-143a and from about 1 to about 5 weight percent hydrogen fluoride.

4. The composition of claim 3 consisting essentially of from about 96 weight percent to about 98 weight percent HFC-143a and from about 2 to about 4 weight percent hydrogen fluoride.

5. A method of forming an azeotropic or azeotrope-like composition which consists essentially of blending from about 1 to about 10 weight percent hydrogen fluoride and from about 90 to about 99 weight percent 1,1,1-trifluoroethane (HFC-143a).

6. The method of claim 5 wherein the composition consists of hydrogen fluoride and 1,1,1-trifluoroethane.

7. The method of claim 6 wherein the composition consists essentially of from about 95 weight percent to about 99 weight percent HFC-143a and from about 1 to about 5 weight percent hydrogen fluoride.

8. The method of claim 7 wherein the composition consists essentially of from about 96 weight percent to about 98 weight percent HFC-143a and from about 2 to about 4 weight percent hydrogen fluoride.

9. A process for removing 1,1,1-trifluoroethane from a mixture containing 1,1,1-trifluoroethane and at least one impurity comprising adding hydrogen fluoride to the mixture in an amount sufficient to form an azeotropic or azeotrope-like composition of the 1,1,1-trifluoroethane (HFC-143a) and the hydrogen fluoride, and thereafter separating the azeotropic composition from the impurity.

10. The process of claim 9 wherein the impurity does not form an azeotropic mixture with HFC-143a, hydrogen fluoride or a mixture of HFC-143a and hydrogen fluoride.

11. The process of claim 9 wherein the impurity comprises a halocarbon.

12. The process of claim 9 wherein the impurity is miscible with HFC-143a.

13. The process of claim 12 wherein the impurity comprises 1,1,1-trichloroethane.

14. The process of claim 12 wherein said separating step comprises distilling said mixture.

15. The process of claim 9 wherein said azeotropic or azeotrope-like composition comprises from about 1 to about 10 weight percent hydrogen fluoride and from about 90 to about 99 weight percent HFC-143a.

16. The process of claim 9 wherein said azeotropic or azeotrope-like composition consists essentially of from about 95 weight percent to about 99 weight percent HFC-143a and from about 1 to about 5 weight percent hydrogen fluoride.
